(19) United States
(12) Patent Application Publication
(10) Pub. No.: US 2008/0273222 A1
(43) Pub. Date: Nov. 6, 2008

(54) System and Method for Saving and Retrieving Job Settings by Printing and Scanning on a Multifunction Document Management System

(76) Inventor: Chengwu Cui, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/744,029

(22) Filed: May 3, 2007

(51) Int. Cl. G06F 3/12

(52) U.S. Cl. 358/1.15

(57) ABSTRACT

A system for saving and retrieving job settings comprising a multifunction document management system and a settings form including a machine recognizable portion printed thereon, wherein the machine recognizable portion includes data indicative of at least one user-selected job setting and wherein the machine recognizable portion is readable by the multifunction document management system.

### TECHNICAL FIELD

The present application relates to multifunction document management systems and, more particularly, to systems and methods for retrieving job settings on multifunction document management systems.

### BACKGROUND

Multifunction document management systems have become commonplace in the home and office environment and may be used to perform a wide variety of tasks, including printing, copying, scanning and/or sending and receiving facsimiles. Typically, multifunction document management systems incorporate two basic components: a scanner component (i.e., an input) and a print engine (i.e., an output). The scanner may convert physical documents and images into electronic data, and the print engine may convert electronic data into physical documents or images. Printing and scanning may be performed on a multifunction document management system by utilizing just one component of the device (i.e., the scanner for scanning or the print engine for printing) while copying may be performed utilizing both components (i.e., the scanner may scan the document, and the print engine may generate copies based upon the scanned data).

Multifunction document management systems typically include various parameters that may be set by the user, such as color, contrast, darkness, number of copies, scale factor, output format (e.g., 8.5×11 paper, PDF file and JPEG file), input format (e.g., size, orientation and one or two-sided), destination electronic mail (e-mail) address, destination facsimile number or the like. The device settings may initially be set to various default values. However, users often have the need to customize one or more of the device settings to achieve a desired result.

Customizing the device settings typically requires the manipulation of several menu options. Furthermore, repeating a previously performed job typically requires a user to commit the job settings to memory and properly select the same job settings upon subsequent use. Therefore, the process for selecting job settings on prior art multifunction document management systems may be inconvenient, tedious and time consuming.

Accordingly, there is a need for an improved system and method for saving and retrieving user-selected job settings on a multifunction document management system.

### SUMMARY

In one aspect, the disclosed system for saving and retrieving job settings may include a multifunction document management system and a settings form including a machine recognizable portion printed thereon, wherein the machine recognizable portion includes data indicative of at least one user-selected job setting and wherein the machine recognizable portion is readable by the multifunction document management system.

In another aspect, a form for saving user-selected job settings for use in a multifunction device may include a machine recognizable portion having data indicative of at least one user-selected job setting, wherein the multifunction device is adapted to perform a document management task based upon the user-selected job setting.

In another aspect, a method for executing a task on a multifunction document management system may include receiving a settings form having a machine recognizable portion indicative of at least one user-selected job setting, configuring the multifunction document management system with the at least one user-selected job setting and performing the task based upon the configuration of the multifunction document management system.

Other aspects of the disclosed system and method for saving and retrieving job settings will become apparent from the following description, the accompanying drawings and the appended claims.

### BRIEF DESCRIPTION OF THE DRAWINGS

FIG. 1 is a block diagram of one aspect of the disclosed multifunction document management system;

FIG. 2 is an illustration of a sample settings form for use in the system of FIG. 1; and

FIG. 3 is a flow diagram of one aspect of the disclosed system and method for executing a task based upon user-selected job settings.

### DETAILED DESCRIPTION

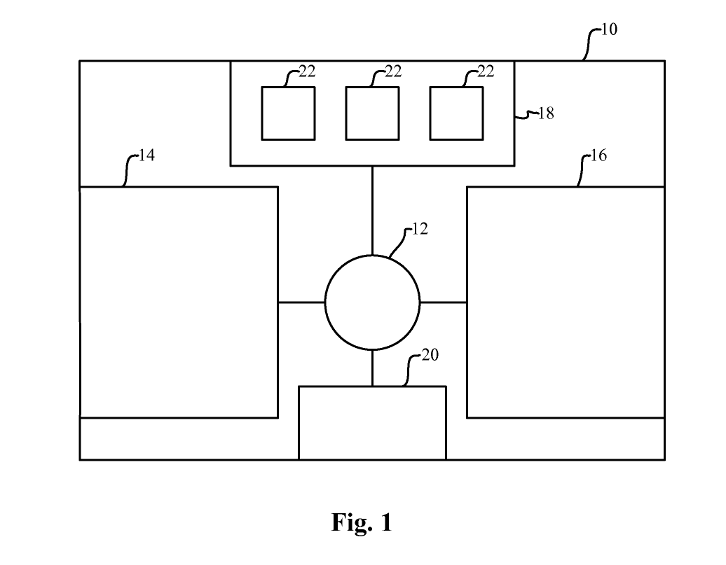

An aspect of the disclosed multifunction document management system and associated method may be embodied in an all-in-one print device, generally designated 10 in FIG. 1. The device 10 may include a processor 12 in communication with a print engine 14, a scanner 16, a control panel 18 and a graphical display 20. Optionally, the device 10 may be in communication with a computer, various networks (e.g., PSTN and/or LAN) and/or the Internet to facilitate the transfer of data to and from the device 10.

The control panel 18 may include various input devices 22 (e.g., buttons, scroll bars, keyboards and the like) capable of communicating a user's desired inputs and parameter settings (collectively, user-selected job settings) to the processor 12 such that the device 10 performs a document management task in accordance with the user-selected job settings. Therefore, a user may navigate through various menus or screens on the graphical user interface or display 20 to select the desired job settings by manipulating the input devices 22 on the control panel 18. In one aspect, the control panel 18 and graphical display 20 may be one and the same, such as a touch screen user interface.

Without limitation, the document management tasks capable of being performed by the device 10 may include printing text, images and/or photographs, scanning text, images and/or photographs, sending and receiving facsimiles, sending and receiving e-mail, copying documents and combinations and variations thereof.

Furthermore, without limitation, the user-selected job settings may include resolution, duplex, color, contrast, darkness, number of copies, scale factor, output format (e.g., 8.5×11 paper, PDF file and JPEG file), input format (e.g., size, orientation and one or two-sided), destination e-mail address, destination facsimile number, border erase, type of content, login information (e.g., username and password) and the like. However, those skilled in the art will appreciate that the user-selected job settings may include any parameter that may be changed or manipulated by the user and any additional information that may be provided by the user.

After the user has input the user-selected job settings, the print engine 14 of the device 10 may print a settings form or sheet 24, wherein the settings form 24 is readable by the device 10 and includes instructions indicative of the input user-selected job settings. In one aspect, the settings form 24 may be printed on any substrate or media capable of being scanned by the scanner 16, such as, for example, standard or letter-quality printer paper.

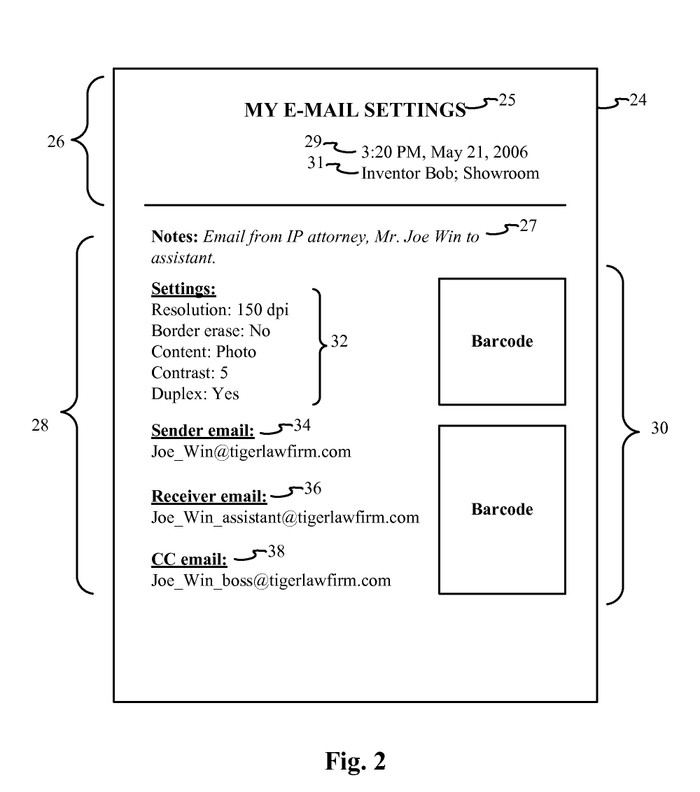

An example of a settings form 24 for setting scan to e-mail settings is illustrated in FIG. 2 and may include a heading portion 26, a human recognizable portion 28 and a machine recognizable portion 30. However, those skilled in the art will appreciate that the settings form 24 may include various portions and information in addition to the machine recognizable portion 30 or, alternatively, only a machine recognizable portion 30.

The heading portion 26 of the settings form 24 may include a title 25 of the settings form 24, a notes section 27 customizable with input by the user (e.g., a brief summary of the contents of the settings form 24), the date and/or time 29 the settings form 24 was created, the name and/or identity of the person who and/or the location 31 of the device 10 which created the settings form 24. However, those skilled in the art will appreciate that the heading portion 26 of the settings form 24 may exclude any of the information enumerated above or may optionally include any other information that may assist a user in identifying a specific settings form 24 at a later time.

The human recognizable portion 28 of the settings form 24 may include a listing of the job settings selected by the user for a particular task. In particular, the human recognizable portion 28 of the settings form 24 may include a listing of the user-selected job settings that will be established if the settings form 24 is scanned by the scanner 16 of the device 10. For example, as shown in FIG. 2, the human recognizable portion 28 may include an outline or listing 32 of the device 10 settings, the e-mail address of the sending party 34, the e-mail address of the receiving party 36 and the e-mail address of any copied party 36.

As will be appreciated by one of ordinary skill in the art, the user-selected job settings captured by the settings form 24 may differ and vary according to the task to be performed by the device 10. The settings form 24 may also include default settings of the device 10 for settings not overridden by the user selections. For example, if the setting form is to be used for sending facsimiles, the settings form may include the facsimile number of the receiving party instead of the e-mail address of the receiving party 36.

The machine recognizable portion 30 may include instructions corresponding to the user-selected job settings, wherein the instructions are capable of being read by the device 10 (e.g., by the scanner 16 of the device 10). In one aspect, the machine recognizable portion 30 may include a special code that is robust for machine recognition or interpretation, such as by means of optical mark recognition (OMR) or special optical character recognition (OCR). For example, the machine recognizable portion 30 may be a bar code into which the instructions are encoded or stored. In another aspect, the machine recognizable portion 30 may be printed in a consistent form at a consistent location on the settings form 24 to improve the recognition of the machine recognizable portion 30 by the device 10.

Those skilled in the art will appreciate that the human recognizable portion 28 and the machine recognizable portion 30 may be one and the same. Further, those skilled in the art will appreciate that instructions or parameters for other device settings not defined or modified by the user may be included in the machine recognizable portion 30.

Prior to performing a document management task on the device 10, the machine recognizable portion 30 of the settings form 24 may be scanned by the scanner 16 of the device 10 such that the device 10 is configured with the user-selected job settings associated with the settings form 24. Alternatively, means other than the scanner 16 may be provided with device 10 for reading the machine recognizable portion 30 of the settings form 24, such as, for example, a bar code scanner.

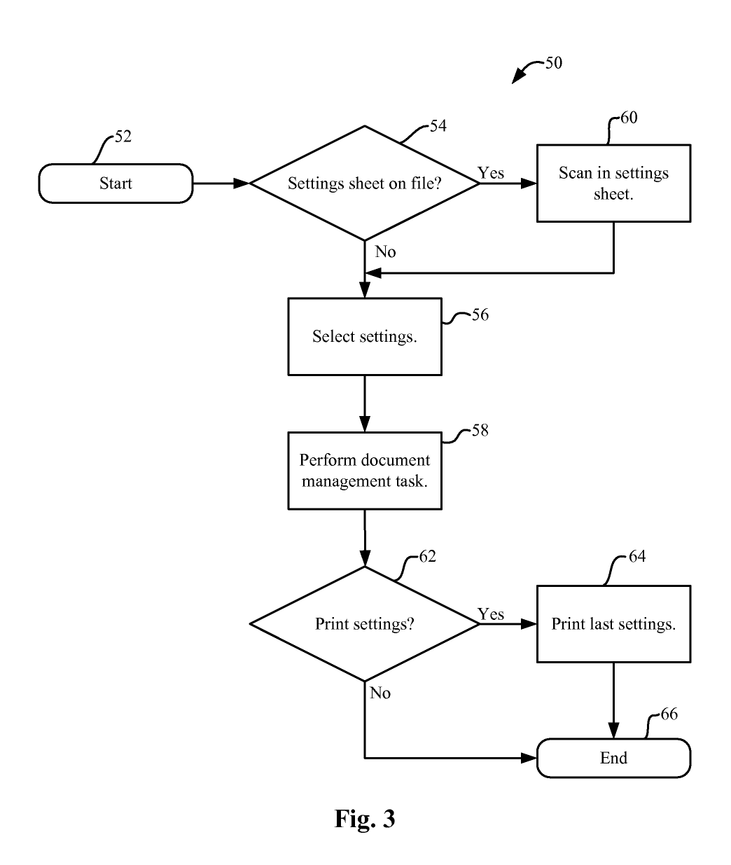

Referring to FIG. 3, one aspect of the disclosed system and method, generally designated 50, may begin at block 52 by, for example, initiating a document management task at the device 10. At block 54, the device 10 may query whether the user has a settings form 24 for the task to be performed. If no settings form 24 is provided or detected, or if the user indicates there is no settings form 24 for the particular task, then, at block 56, the user may use the default device 10 settings or enter user-selected job settings by way of the input devices 22 of the control panel 18 and, at block 58, the task may be performed accordingly. However, if the user provides a settings form 24 for the desired task, then, at block 60, the settings form 24 may be read (e.g., scanned) by the device 10 such that the user-selected job settings associated with the settings form 24 are communicated to the device 10, and the device 10 is configured with such user-selected job settings. Optionally, the user may enter additional user-selected settings by way of the input devices 22 of the control panel 18. The task is then performed according to the user-selected job settings (block 58). For example, the settings form 24 may be read by scanning the settings form 24 with the scanner 16 of the device 10, and the device 10 performs a scan to e-mail task using the user-selected settings enumerated in the human recognizable portion 28 of the settings form 24 (see FIG. 2).

After completing the document management task (block 58), at block 62 the device 10 may query whether the user requires a newly printed settings form 24. If the user indicates “yes,” then, at block 64, the print engine 14 may print a new settings form 24, and the process may come to an end at block 66. The new settings form 24 may include the user-selected job settings of the document management task most recently performed. If the user indicates “No,” then the process may come to an end at block 66.

As is known in the art, the device 10 settings for the most recent task may remain set until changed by the same or a subsequent user or until a scan another settings form. The device 10 settings may also automatically be reset to the default settings after a predetermined or preset period of time.

Accordingly, the disclosed system and method for saving and retrieving user-selected job settings on a multifunction document management system allows a user to eliminate the need for navigating through screens and menus to input device settings for a desired job or task. More efficiently, according to the disclosed system and method, a user may print a settings form 24 for future use that includes user-selected job settings in machine readable format, wherein the user-selected job settings are read and implemented by the device 10. Thus, users may more easily set device settings for their more commonly used tasks, and multiple users of the same device 10 may more easily share the device 10 without having to re-enter their desired job settings prior to each use of the device 10. Furthermore, the disclosed system and method allow the user-selected job settings to be transferred to or used on other devices similar to the device 10.

Although various aspects of the disclosed system and method for saving and retrieving user-selected job settings have been shown and described, modifications may occur to those skilled in the art upon reading the specification. The present application includes such modifications and is limited only by the scope of the claims.

What is claimed is:

1. A system for saving and retrieving user-selected job settings, comprising:
a multifunction document management system, and
a settings form including a machine recognizable portion printed thereon,
wherein said machine recognizable portion includes data indicative of at least one user-selected job setting and wherein said machine recognizable portion is readable by said multifunction document management system.

2. The system of claim 1, wherein said multifunction document management system includes a print engine and a scanner.

3. The system of claim 2, wherein said machine recognizable portion is readable by said scanner.

4. The system of claim 1, wherein said multifunction document management system includes a control panel having at least one input device.

5. The system of claim 1, wherein said multifunction document management system is adapted to send electronic mail.

6. The system of claim 1, wherein said machine recognizable portion is printed by said multifunction document management system.

7. The system of claim 1, wherein said settings form is formed from paper.

8. The system of claim 1, wherein said settings form further includes a human recognizable portion printed thereon.

9. The system of claim 1, wherein said settings form further includes a heading portion printed thereon.

10. The system of claim 1, wherein said machine recognizable portion includes at least one of an optical mark recognition code and an optical character recognition code.

11. The system of claim 1, wherein said machine recognizable portion includes a bar code.

12. The system of claim 1, wherein said multifunction document management system is adapted to perform a document management task based upon said at least one user-selected job setting.

13. A form for saving user-selected job settings for use in a multifunction device, comprising:
a machine recognizable portion having data indicative of at least one user-selected job setting, wherein said multifunction device is adapted to perform a document management task based upon said at least one user-selected job setting.

14. The form of claim 13, wherein said human recognizable portion.

15. The form of claim 13, wherein said form further includes a heading portion printed thereon.

16. The form of claim 13, wherein said machine recognizable portion includes at least one of an optical mark recognition code and an optical character recognition code.

17. The form of claim 13, wherein said machine recognizable portion includes a bar code.

18. A method for executing a task on a multifunction document management system, comprising:
receiving a settings form having a machine recognizable portion indicative of at least one user-selected job setting;
configuring said multifunction document management system with the at least one user-selected setting; and
performing the task based upon said configuration of the multifunction document management system.

19. The method of claim 18, wherein said configuring includes setting at least one setting of the multifunction document management system according to said at least one user-selected job setting.

20. The method of claim 18, further comprising printing a second settings form, wherein said second settings form comprises code based upon said at least one user-selected job setting.
